(19) United States
(12) Patent Application Publication
(10) Pub. No.: US 2010/0226088 A1
(43) Pub. Date: Sep. 9, 2010

(54) Heat-Dissipation, Connection and Support Structure for Notebook Computer

(76) Inventor: Cheng Yu Huang, Taipei (TW)

Correspondence Address: Jackson Intellectual Property Group PLLC, 106 Starvale Lane, Shipman, VA, 22971, US

(21) Appl. No.: 12/146,180

(22) Filed: Jun. 25, 2008

(51) Int. Cl. G06F 1/20

(52) U.S. Cl. 361/679.48

(57) ABSTRACT

A heat-dissipation, connection and support structure for a notebook computer is characterized by integration of a heat-dissipation base, a connection device and an angle-adjusting supporting device into one piece, wherein the heat-dissipation base allows the notebook computer to be placed thereon and is provided with a replaceable cooling fan, a fan speed regulating device, at least one adjustable pad, at least one rotatable stopper, a cord compartment cover, an indicator lamp, a switch and various connecting ends. The angle-adjusting supporting device is provided on the backside of the heat-dissipation base for adjusting a supporting angle, so that the structure not only provides heat-dissipation and connection functions, but can also support the notebook computer at various inclination angles.

### BACKGROUND OF THE INVENTION

1. Technical Field

The present invention relates to a heat-dissipation, connection and support structure for a notebook computer, wherein a heat-dissipation base, a connection device and a supporting device are integrated into one piece, so that the heat-dissipation base not only allows the notebook computer to be placed thereon and supported at various inclination angles, but also provides heat-dissipation and connection functions.

2. Description of Related Art

Notebook computers, or otherwise known as laptop or portable computers, are lightweight, compact in size, and suitable for being carried around and used at any desired location. The prevalence of wireless networking further accentuates the convenience of notebook computers and gives them another name: “mobile computers.” However, the operation of notebook computers is also restricted by their size and structure and therefore they are less ergonomic. In addition, compared with desktop PCs, notebook computers have far poorer heat-dissipation capabilities, allow much shorter operation time and are less convenient in terms of external connections.

Generally, if a notebook computer is used only for a short time, no heat-dissipation problems will occur. After extended use, however, the notebook computer tends to overheat, especially on its underside where the hard drive, CPU and power supply are located. When the notebook computer is overheated, its hard drive or the entire computer may be damaged or even injure its user. As a result, the overheating problem of notebook computers has become an issue that cannot be ignored.

To overcome the heating effect of notebook computers, a heat-dissipation seat for a notebook computer was developed to provide auxiliary heat dissipation to the notebook computer placed on the seat. And this heat-dissipation seat has been an ideal solution to the overheating problem

In addition, connection between a notebook computer and external power supplies, audio devices and digital peripherals is another issue to be addressed.

Besides, the less ergonomic operation of a notebook computer tends to cause the keyboard syndrome, afflicting a user with arthritis and tendonitis of the hands. Moreover, if a notebook computer is placed on a tabletop or laptop and used for a long time, the user is also susceptible to other immediate or potential injuries.

In order to prevent such work injury, a supporting device for a notebook computer has emerged in recent years that allows adjustment of its inclination angle so that the notebook computer can be supported by the device at a desired inclination angle and operated via an external or wireless keyboard or mouse. This supporting device is advantageous in allowing a screen of the notebook computer to be displayed at a desired angle, and freeing its user from the restriction that his or her hands must be placed on the notebook computer's keyboard or mouse to operate the notebook computer, thereby protecting the user from injury due to long-term improper hand posture.

### BRIEF SUMMARY OF THE INVENTION

In view of the aforementioned shortcomings of conventional notebook computers, the inventor of the present invention applied years of experience in the research, development, production and sales of related products, and finally succeeded in developing a heat-dissipation, connection and support structure for a notebook computer, the structure being characterized in that a heat-dissipation base, a connection device and a supporting device are integrated into one piece. The heat-dissipation base allows the notebook computer to be placed thereon and is provided with a replaceable cooling fan, a fan speed regulating device, at least one adjustable pad, at least one rotatable stopper, a cord compartment cover, an indicator lamp, a switch and various connecting ends. The supporting device is provided on the backside of the heat-dissipation base for adjusting a supporting angle, so that the structure not only provides heat-dissipation and connection functions, but can also support the notebook computer at arbitrary inclination angles to suit a user's personal habits.

### BRIEF DESCRIPTION OF THE SEVERAL VIEWS OF THE DRAWINGS

The invention as well as a preferred mode of use, further objectives and advantages thereof will best be understood by reference to the following detailed description of illustrative embodiments when read in conjunction with the accompanying drawings, wherein:

FIG. 1 is an exploded perspective view of components of a heat-dissipation, connection and support structure according to a first preferred embodiment of the present invention;

FIG. 2 is a perspective view of the structure according to the first preferred embodiment of the present invention, wherein the structure serves connection and heat-dissipation functions;

FIG. 3 is another perspective view of the structure according to the first preferred embodiment of the present invention, wherein the structure serves the connection and heat-dissipation functions;

FIG. 4 is a perspective bottom view of the structure according to the first preferred embodiment of the present invention, wherein the structure serves the connection and heat-dissipation functions;

FIG. 5 is a side view of the structure according to the first preferred embodiment of the present invention, wherein the structure serves the connection and heat-dissipation functions;

FIG. 6 is another side view of the structure according to the first preferred embodiment of the present invention, wherein the structure serves the connection and heat-dissipation functions;

FIG. 7 is a perspective bottom view of the structure according to the first preferred embodiment of the present invention, wherein the structure serves the connection and heat-dissipation functions as well as a supporting function;

FIG. 8 is another perspective bottom view of the structure according to the first preferred embodiment of the present invention, wherein the structure simultaneously serves the connection, heat-dissipation and supporting functions;

FIG. 9 is a perspective bottom view of the structure according to the first preferred embodiment of the present invention, wherein the structure simultaneously serves the connection, heat-dissipation and supporting functions;

FIG. 10 is a side view of the structure according to the first preferred embodiment of the present invention, wherein the structure simultaneously serves the connection, heat-dissipation and supporting functions;

FIG. 11 is an exploded perspective view of components of a heat-dissipation, connection and support structure according to a second preferred embodiment of the present invention;

FIG. 12 is a perspective view of the structure according to the second preferred embodiment of the present invention; and

FIG. 13 is a side view of the structure according to the second preferred embodiment of the present invention, wherein the structure simultaneously serves connection, heat-dissipation and supporting functions.

### DETAILED DESCRIPTION OF THE INVENTION

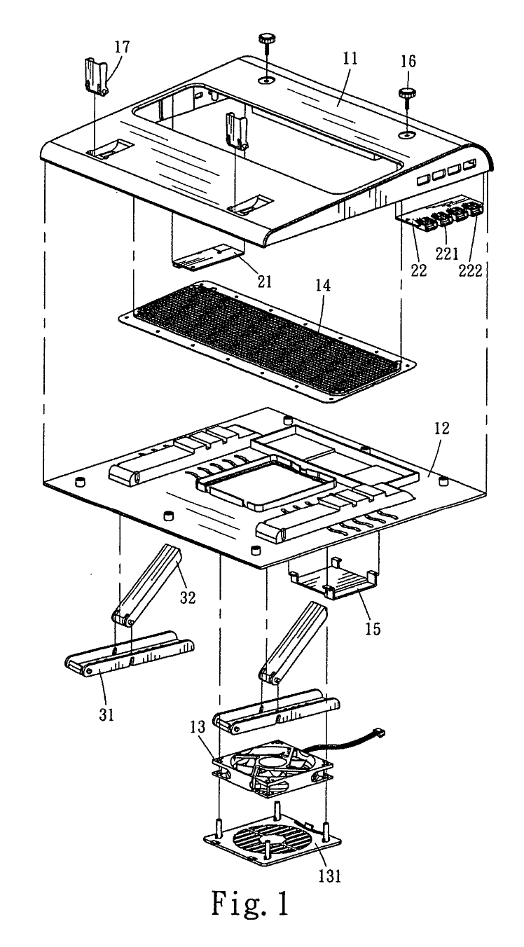

Referring to FIG. 1, a heat-dissipation, connection and support structure for a notebook computer according to a first preferred embodiment of the present invention comprises a heat-dissipation base, a connection device and a supporting device.

The heat-dissipation base comprises an upper plate 11 and a lower plate 12 coupled to each other to form a base shell. On the lower plate 12 is further provided with a cooling fan 13, a fan screen 131, a ventilation screen 14, a cord compartment cover 15, adjustable pads 16 and rotatable stoppers 17.

It is worth mentioning that the cooling fan 13 and the fan screen 131 are so configured that the cooling fan 13 can be replaced when it is out of order, and that the cooling fan 13 can be mounted in two opposite directions to convert blowing into suction and vice versa.

The connection device is disposed on two lateral sides of the heat-dissipation base and comprises a power input/VR control circuit board 21 and a HUB connection circuit board 22. The power input/VR control circuit board 21 is provided with a power input end 211, a switch 212, an indicator lamp 213 and a VR control device 214, which allows a user to adjust a revolving speed of the cooling fan 13 at any time. The HUB connection circuit board 22 is provided with USB connection terminals 221 and 222 for connection with a variety of computer peripherals.

The supporting device is installed in preformed recesses on two sides of the lower plate 12 and comprises primary supporting elements 31 and secondary supporting elements 32. The supporting device can be put up and allows adjustment of height.

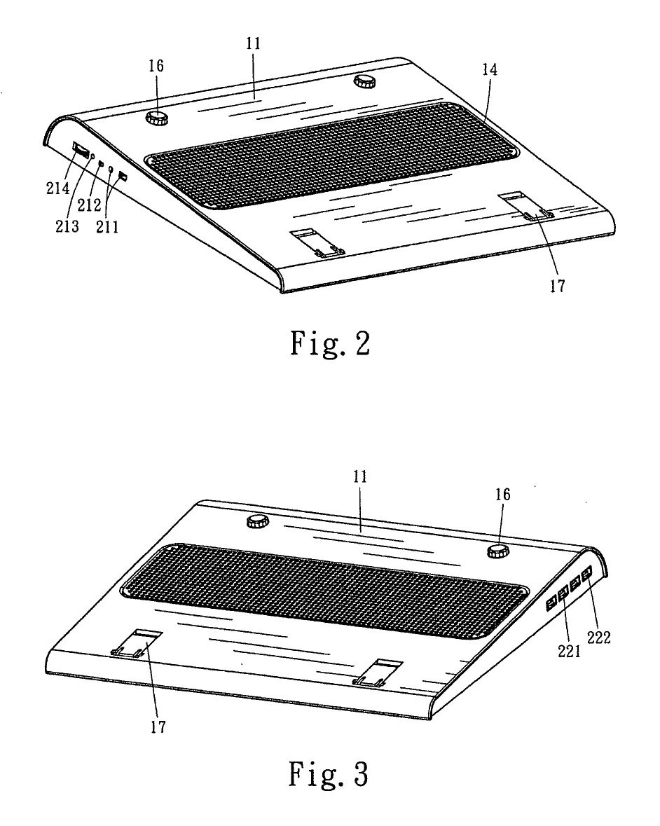

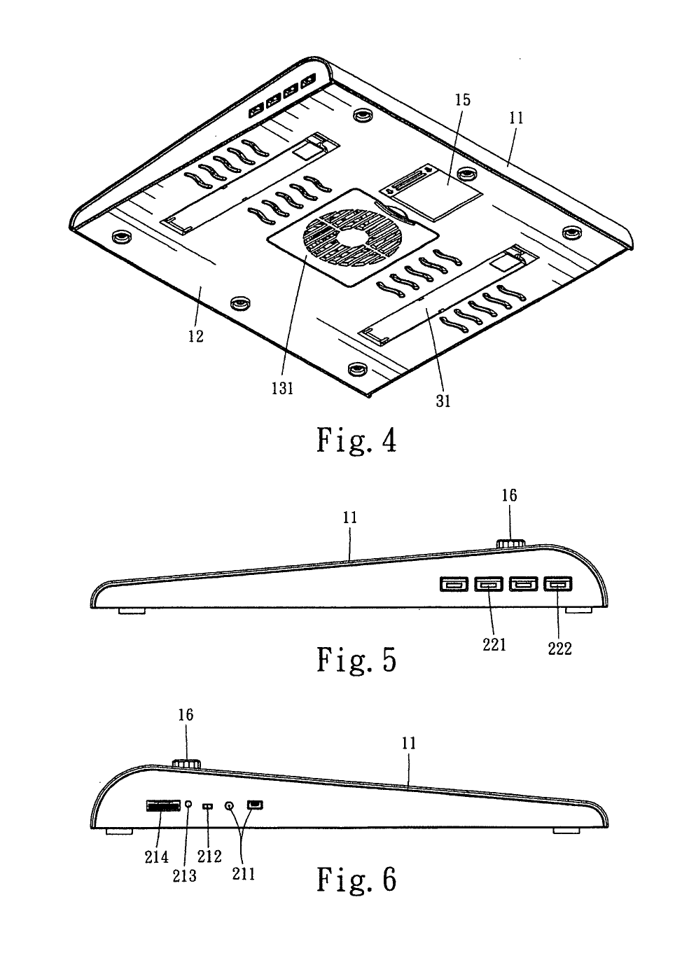

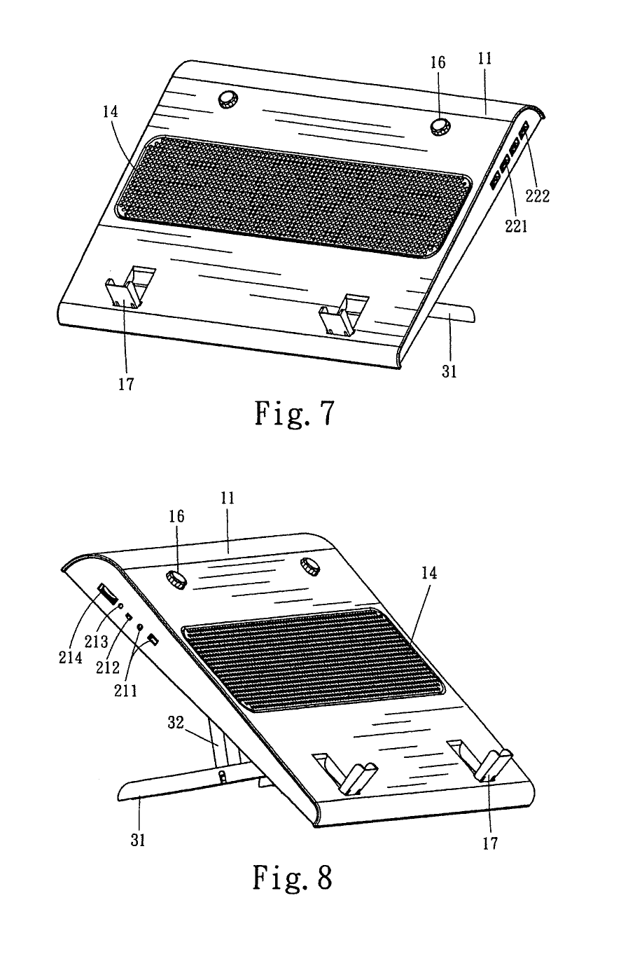

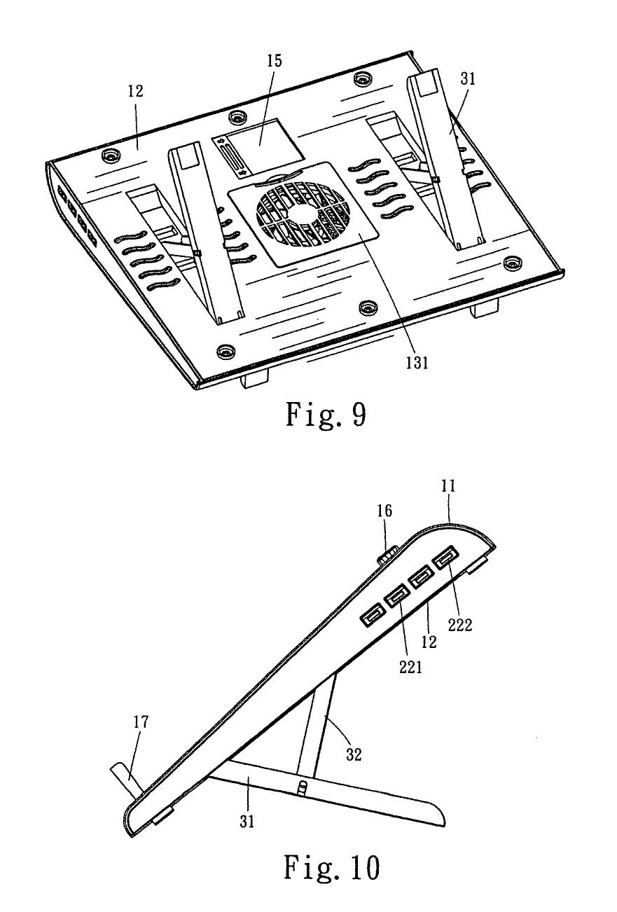

In conclusion, while the structure according to the present invention has heat-dissipation, connection and supporting functions, it can be used only to dissipate heat generated by the notebook computer and connect to peripherals, as shown in FIGS. 2 to 6. Alternatively, if the supporting device of the structure according to the present invention is put up and adjusted to a desired height, the structure can be used to support the notebook computer as well, as shown in FIGS. 7 to 10.

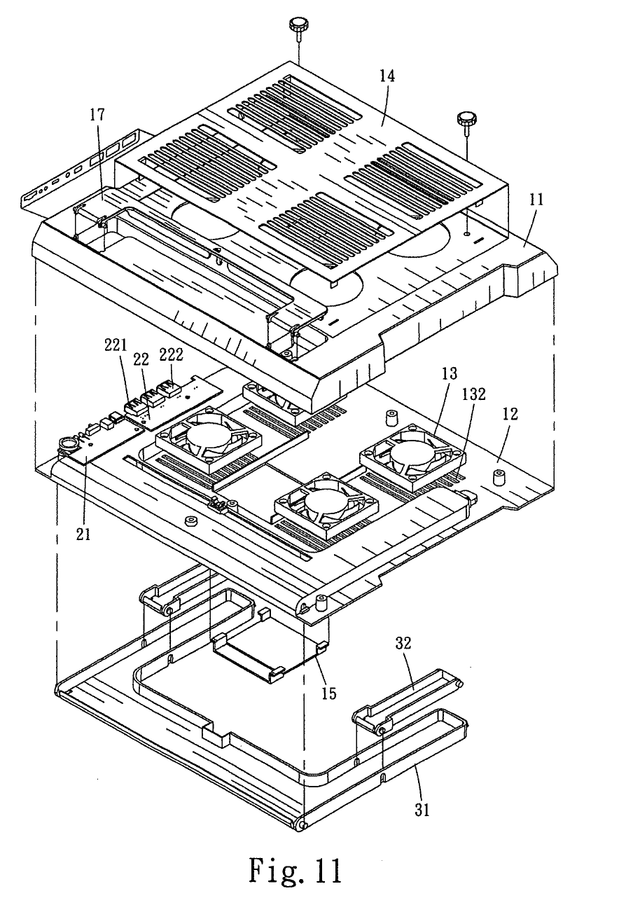

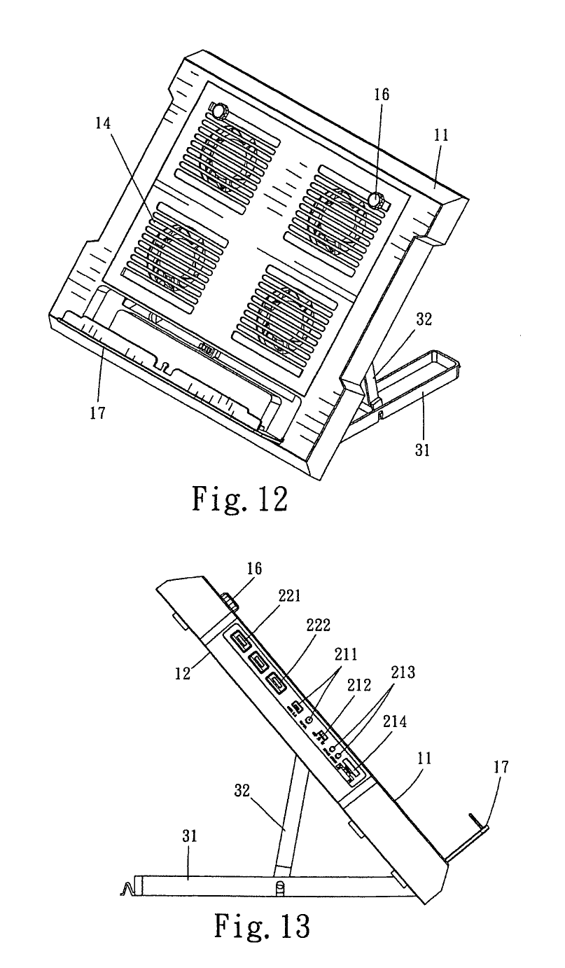

Referring to FIGS. 11 to 13, the aforementioned components of the present invention can be modified to produce a second preferred embodiment of the present invention. In a heat-dissipation, connection and support structure for a notebook computer according to the second preferred embodiment of the present invention, the rotatable stoppers 17 are designed as a strip-like stopper, the lower plate 12 is provided with fixed ventilation holes 132 and a plurality of cooling fans 13, and the primary supporting elements 31 are designed as an M-shaped primary supporting element.

The present invention has been described with preferred embodiments thereof and it is understood that the embodiments are not intended to limit the scope of the present invention. Moreover, as the content disclosed herein should be readily understood and can be implemented by a person skilled in the art, all equivalent changes or modifications which do not depart from the spirit of the present invention are encompassed by the appended claims.

1. A heat-dissipation, connection and support structure for a notebook computer, comprising:
a heat-dissipation base comprising an upper plate and a lower plate coupled to each other to form a base shell, wherein a lower plate is provided mainly with a cooling fan, at least one adjustable pad, and at least one rotatable stopper;
a connection device disposed on lateral sides of the heat-dissipation base and comprising a power input/VR control circuit board and a HUB connection circuit board; and
a supporting device provided on the heat-dissipation base and comprising at least one primary supporting element and at least one secondary supporting element that allow adjustment of an inclination angle;
wherein the heat-dissipation, connection and support structure can serve only connection and heat-dissipation functions, or serve the connection and heat-dissipation functions and a supporting function at a same time.

2. The heat-dissipation, connection and support structure for the notebook computer claimed in claim 1, wherein the rotatable stopper is designed as a rotatable strip-like stopper, the fan screen on the lower plate is designed as fixed ventilation holes, and the primary supporting element is designed as an M-shaped primary supporting element.
